(19) United States
(12) Patent Application Publication
(10) Pub. No.: US 2021/0317327 A1
(43) Pub. Date: Oct. 14, 2021

(54) GRAPHENE-BASED CONDUCTIVE INK AND PREPARATION THEREOF

(71) Applicant: Huaqiao University, Quanzhou (CN)

(72) Inventors: Guohua CHEN, Quanzhou (CN); Xinbin QIU, Quanzhou (CN); Feixiang LIU, Quanzhou (CN)

(21) Appl. No.: 17/358,268

(22) Filed: Jun. 25, 2021

Related U.S. Application Data
(63) Continuation of application No. PCT/CN2020/103705, filed on Jul. 23, 2020.

(30) Foreign Application Priority Data
May 27, 2019 (CN) 201910444840.X

(51) Int. Cl. C09D 11/52; C09D 11/037; C09D 11/033; C09D 11/023; C09D 11/107; C01B 32/19; C01B 32/225

(52) U.S. Cl. CPC C09D 11/52; C09D 11/037; C09D 11/033; C09D 11/023; B82Y 30/00; C01B 32/19; C01B 32/225; C01B 2204/22; C09D 11/107

(57) ABSTRACT

Graphene-based conductive ink and a preparation thereof. The graphene-based conductive ink includes a modified graphene nanomaterial, a first solvent and an ink binder. The modified graphene nanomaterial is prepared by subjecting a mixture of sodium sulfanilate, a natural flake graphite and a second solvent to liquid phase exfoliation. The second solvent is a mixture of water and a second alcohol.

### CROSS-REFERENCE TO RELATED APPLICATIONS

This application is a continuation of International Patent Application No. PCT/CN2020/103705, filed on Jul. 23, 2020, which claims the benefit of priority from Chinese patent application No. 201910444840.X, filed on May 27, 2019. The content of the aforementioned applications, including any intervening amendments thereto, are incorporated herein by reference.

### TECHNICAL FIELD

This application relates to grapheme materials, and more particularly to a graphene-based conductive ink and a preparation thereof.

### BACKGROUND

Conductive ink is a composite material composed of a conductive filler, a binder, a solvent and various auxiliaries, where the conductive filler is a key phase that affects performance of the conductive ink. Countless conductive particles are uniformly dispersed in the binder and the ink solvent of the conductive ink. Liquid conductive ink is insulative, while patterns or printed films obtained by the printing of the conductive ink have a certain electrical conductivity after being annealed.

Traditional electronic devices and energy-storage devices are prepared by photoetching, chemical etching, chemical plating and vacuum deposition, which have defects of expensive metal substrates, complicated processes and environmental pollution. In the 1990s, the conductive ink has achieved a certain advancement, and with the renovation of the traditional silicon-based electronic information technology, the modern electronic printing technology i.e., conductive ink-based printing, is developed. Various printing conductive inks, such as metal-based conductive ink, polymer-based conductive ink and carbon-based conductive ink, have been developed, and among them, the conductive silver paste has been demonstrated to have excellent conductivity and a certain applicability. However, silver nanoparticles are prone to silver migration and sedimentation, and the metallic silver also has a high price, limiting the use of the conductive silver paste. As another metal-based conductive ink, the conductive copper paste has a relatively low cost, but it is also greatly limited in the application and development due to poor oxidation resistance of copper nanoparticles. In addition, the polymer-based conductive ink (such as poly(3,4-ethylenedioxythiophene) (PEDOT)-based conductive ink and poly(sodium-p-styrenesulfonate) (PSS)-based conductive ink) has poor stability, poor weather resistance and low conductivity, and the PEDOT/PSS-based conductive ink generally needs to be appropriately doped.

Compared to the above-mentioned printing conductive ink, the graphene-based conductive ink has good corrosion resistance and flexibility, light weight and low cost, does not cause environmental pollution. The development of preparation of graphene further broadens application of the graphene-based conductive ink in various fields, such as flexible electronic screens, functional sensors, photovoltaic cells, printed microcircuits and radio frequency identification devices (RFIDs). Due to the unique advantages of low cost, good industrial applicability and environmental protection, the grapheme-based conductive ink has a promising prospect in the research and development of a flexible electronic device.

As a new generation of conductive material, graphene has a high charge mobility. It has been measured by Kirill Bolotin from Columbia University that the charge mobility of the graphene with structural integrity reaches 2.5×10⁵ cm²/(V·s), which is 100 times that of the single-crystal silicon material. Moreover, the charge mobility of the graphene is not prone to be affected by temperature. Each carbon atom in the graphene structure provides an unbonded π electron and can move freely on the surface of the graphene crystal, such that the graphene has an ultra-high electron mobility.

As a consequence, the graphene has a great potential to be applied as a conductive material in the fields of energy storage, signal transmission, sensor detection and composite material.

### SUMMARY

An object of this application is to provide a graphene-based conductive ink and a preparation thereof to overcome the above technical problems.

Technical solutions of the present disclosure are described as follows.

In a first aspect, this application provides a graphene-based conductive ink, comprising:

a modified graphene nanomaterial;

a first solvent; and

an ink binder;

wherein a weight ratio of the modified graphene nanomaterial to the first solvent to the ink binder is (2-4):(50-100):(1-2); and the first solvent is a mixture of water and a first alcohol;

the modified graphene nanomaterial is prepared by subjecting a mixture of sodium sulfanilate, a natural flake graphite and a second solvent to liquid phase exfoliation; and

the second solvent is a mixture of water and a second alcohol.

In some embodiments, a particle size of the natural flake graphite is 4000-10000 mesh. In some embodiments, the particle size of the natural flake graphite is 8000 mesh.

In some embodiments, a weight ratio of the natural flake graphite to the sodium sulfanilate is 1:(0.2-10).

In some embodiments, the weight ratio of the natural flake graphite to the sodium sulfanilate is 1:(0.5-2).

In some embodiments, a volume ratio of the water to the first alcohol in the first solvent is 1:(0.5-2), preferably 2:3.

In some embodiments, a volume ratio of the water to the second alcohol in the second solvent is 1:(0.5-2), preferably 2:3.

In some embodiments, the first alcohol and the second alcohol are independently a lower alcohol.

In some embodiments, the lower alcohol is selected from the group consisting of ethanol, ethylene glycol, glycerol, isopropanol, n-butanol and a combination thereof, preferably isopropanol.

In some embodiments, the ink binder is selected from the group consisting of polyvinyl alcohol, polyethylene glycol, acrylic resin, epoxy resin, polyurethane resin, hydroxypropyl methylcellulose, nitrocellulose and a combination thereof.

In a second aspect, this application further provides a method of preparing the graphene-based conductive ink, comprising:

(1) mixing the natural flake graphite, the second solvent and the sodium sulfanilate followed by ultrasonication to obtain a graphite dispersion;

(2) grinding the graphite dispersion obtained in step (1) to obtain a ground slurry;

(3) subjecting the ground slurry obtained in step (2) to centrifugal washing with a third solvent to obtain the modified graphene nanomaterial; and

(4) mixing the modified graphene nanomaterial obtained in step (3), the ink binder and the first solvent followed by ultrasonication and grinding to obtain the graphene-based conductive ink.

In some embodiments, in step (2), the grinding is performed in a medium of zirconia beads with a particle size of 2-3 mm for 12-24 h.

In some embodiments, in step (2), the grinding is performed at a rotation rate of 1000-2000 rpm, preferably 2000 rpm.

In some embodiments, in step (3), the third solvent is a mixture of water and isopropanol.

In some embodiments, a volume ratio of the isopropanol to the water is 3:2.

In some embodiments, in step (4), the grinding is performed in a medium of zirconia beads with a particle size of 1-3 mm at a rotation rate of 100-500 rpm for 1-2 h. In an embodiment, in step (4), the grinding is performed in the medium of zirconia beads with a particle size of 2 mm at 500 rpm for 2 h.

### BRIEF DESCRIPTION OF THE DRAWINGS

FIG. 1 schematically shows a preparation of a modified graphene nanomaterial according to Example 1 of the present disclosure.

FIGS. 2A-2J show test results of conductivity of a graphene conductive film according to Example 1 of the present disclosure on different substrates, where 2A-C: polyethylene terephthalate (PET) substrate; 2D-E: glass substrate; 2F-G: nylon fiber; 2H: wire; 21: plant; and 2J: paper substrate.

FIG. 3 shows test results of dispersity of the modified graphene nanomaterial (20 mg/mL) prepared in Example 1 of the present disclosure.

FIGS. 4A-4C show performance of the graphene conductive film according to Example 1 of the present disclosure, where 4A: change curve of conductivity of a modified graphene nanomaterial sheet versus pressure; 4B: effect of polishing treatment on resistance of the graphene conductive film (1 cm×1 cm) under different dip coating cycles; and 4C: comparison between the graphene conductive film and a commercial carbon black conductive film in terms of flexibility.

### DETAILED DESCRIPTION OF EMBODIMENTS

Technical solutions of this application will be further described in detail below with reference to the embodiments and accompanying drawings.

### EXAMPLE 1

This embodiment provides a method of preparing a modified graphene nanomaterial, including the following steps.

(1) 10 g of a natural flake graphite with a particle size of 8000 mesh, 10 g of sodium sulfanilate (SAS), 240 mL of isopropanol and 160 mL of distilled water were mixed and subjected to ultrasonication at 5,000 Hz for 60 s to obtain a graphite dispersion.

(2) The graphite dispersion was poured into a basket grinder and subjected to ball milling by zirconia beads (a particle size of 2.5 mm) at 2,000 rpm for 24 h, where during the ball milling process, cooling water was introduced for circulating cooling.

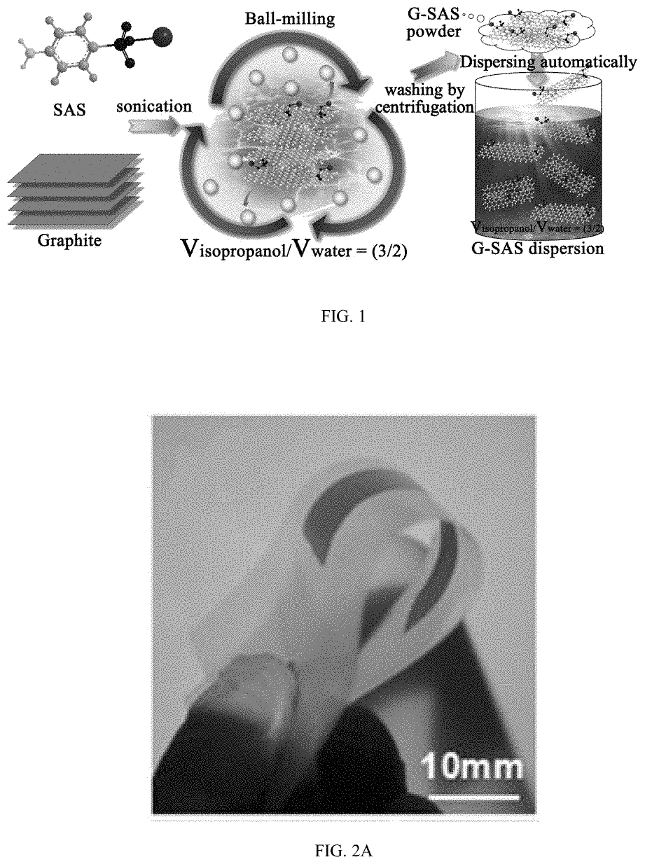

(3) Upper material in the charging basket of the basket grinder was collected and subjected to centrifugal washing 5 times with a mixed solution of isopropanol and water (Vᵢₛₒₚᵣₒₚₐₙₒₗ/V_{water}=3:2) to obtain the modified graphene nanomaterial (G-SAS). In the G-SAS, the sodium sulfanilate adhered to the grapheme surface through π-π conjugation, physical adsorption and chemical grafting. The specific preparation process was shown in FIG. 1.

This embodiment further provides a method of preparing a graphene-based conductive ink, including the following steps.

(1) 5 g of the above-mentioned modified graphene nanomaterial, 1.5 g of an aqueous acrylic resin emulsion, 60 mL of isopropanol and 40 mL of distilled water were mixed and subjected to ultrasonication to obtain an ink dispersion.

(2) The ink dispersion was poured into the basket grinder and subjected to ball milling by zirconia beads (a particle size of 2.5 mm) at 500 rpm for 2 h to obtain a ground slurry as the graphene-based conductive ink, where during the ball milling process, cooling water was introduced for circulating cooling.

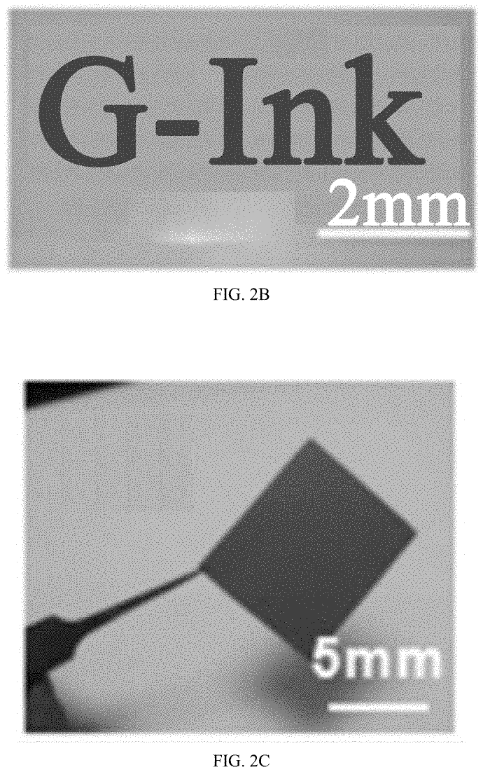

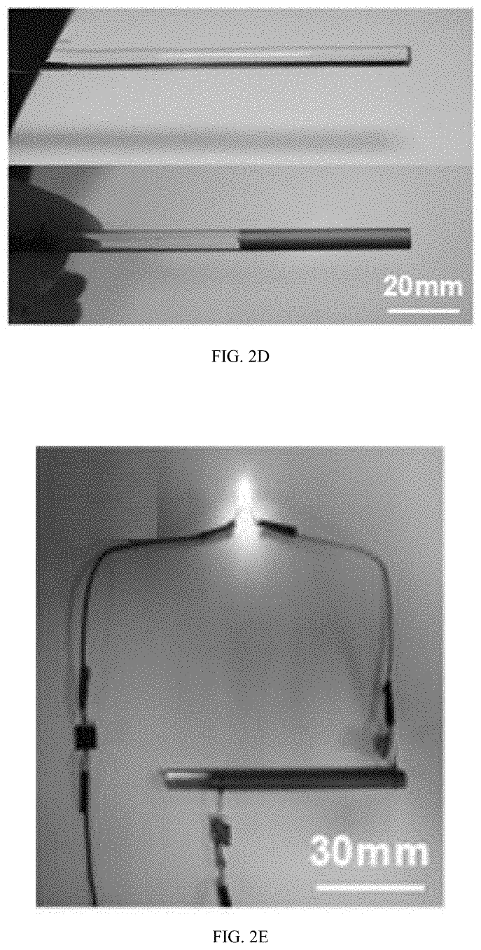

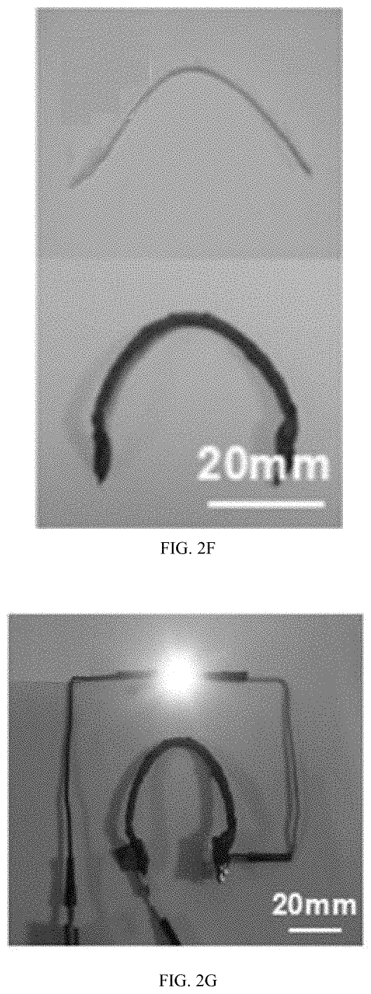

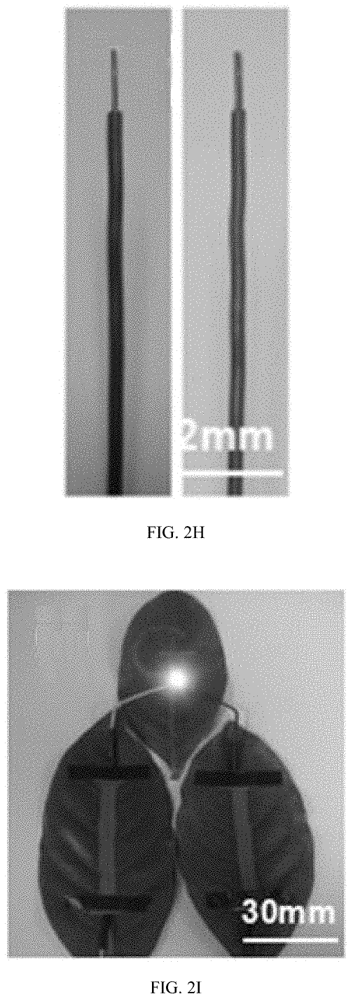

The graphene-based conductive ink was respectively dip-coated on a PET substrate (FIGS. 2A-C), a glass substrate (FIGS. 2D-E), a nylon fiber substrate (FIGS. 2F-G), a wire substrate (FIG. 2H), a plant substrate (FIG. 21) and a paper substrate (FIG. 2J) and then dried at 80° C. in a constant temperature blast oven to obtain a graphene conductive film. These graphene conductive films were respectively connected to a conductive path to test the conductivity, and test results were shown in FIGS. 2A-J. As a result, the light-emitting diodes in FIGS. 2E, G, I and J can emit light, which verified that the modified graphene nanomaterial prepared herein had excellent electrical conductivity.

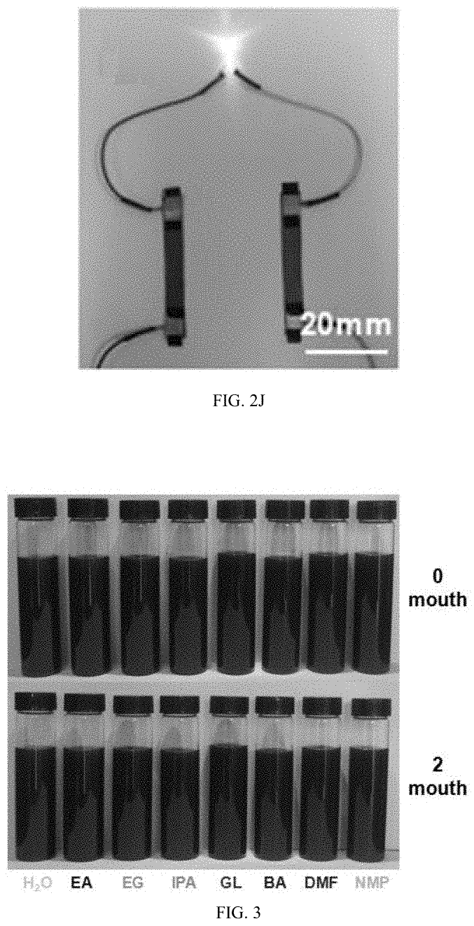

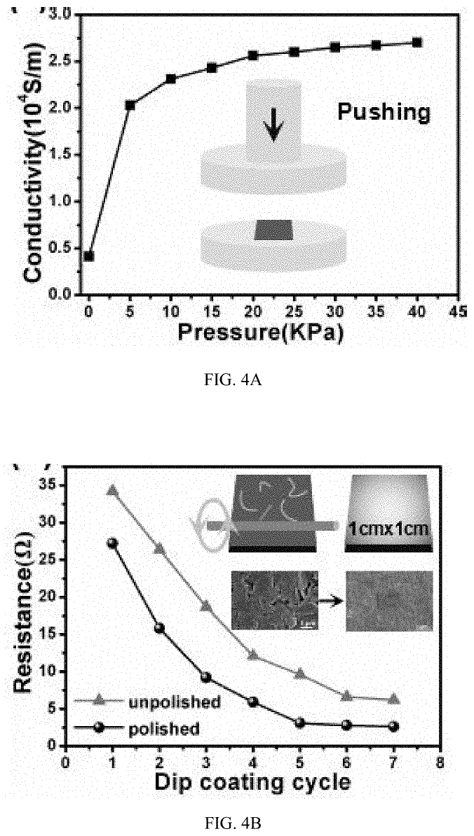

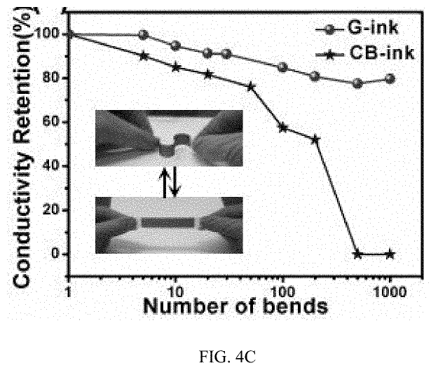

The dispersity of the modified graphene nanomaterial was tested, and the results were shown in FIG. 3. The conductivity of the graphene conductive film was tested by four-point probe method, and the results were shows in FIGS. 4A-C. It can be seen from FIG. 3 that the modified graphene nanomaterial provided herein can experience a two-month stable dispersion in water, ethanol, ethylene glycol, glycerol, n-butanol, isopropanol, dimethylformamide (DMF) and N-methyl pyrrolidone (NMP) as a conductive filler, indicating good dispersion adaptability. As shown in FIG. 4A, the graphene conductive film provided herein had an electrical conductivity of 2.60×10⁴ S/m at a pressure of 25 kPa; as shown in FIG. 4B, the polishing treatment cano greatly improve the conductivity of the graphene conductive film obtained by a simple dip coating process, and at the same time, the polished graphene nanosheet had superior density, uniformity and continuity with respect to the unpolished graphene nanosheet; and as shown in FIG. 4C, the graphene conductive film had a conductivity retention of 79% after thousands of bends, while an ordinary carbon black conductive film almost lost its conductivity after 200 bends due to the destruction of the conductive pathway.

### EXAMPLE 2

This embodiment provides a method of preparing a modified graphene nanomaterial, including the following steps.

(1) 10 g of a natural flake graphite with a particle size of 8000 mesh, 5 g of sodium sulfanilate, 240 mL of isopropanol and 160 mL of distilled water were mixed and subjected to ultrasonication at 5,000 Hz for 60 s to obtain a graphite dispersion.

(2) The graphite dispersion was poured into a basket grinder and subjected to ball milling by zirconia beads (a particle size of 2.5 mm) at 2,000 rpm for 24 h, where during the ball milling process, cooling water was introduced for circulating cooling.

(3) Upper material in the charging basket of the basket grinder was collected and subjected to centrifugal washing 5 times with a mixed solution of isopropanol and water (Vᵢₛₒₚᵣₒₚₐₙₒₗ/V_{water}=3:2) to obtain the modified graphene nanomaterial. The specific preparation process was shown in FIG. 1.

This embodiment further provides a method of preparing a graphene-based conductive ink, including the following steps.

(1) 1 g of the above-mentioned modified graphene nanomaterial, 1 g of an aqueous acrylic resin emulsion, 240 mL of isopropanol and 160 mL of distilled water were mixed and subjected to ultrasonication to obtain an ink dispersion.

(2) The ink dispersion was poured into the basket grinder and subjected to ball milling by zirconia beads (a particle size of 2.5 mm) at 500 rpm for 2 h to obtain a ground slurry as the graphene-based conductive ink, where during the ball milling process, cooling water was introduced for circulating cooling.

The graphene-based conductive ink was respectively dip-coated on a PET substrate, a glass substrate, a nylon fiber substrate, a wire substrate, a plant substrate and a paper substrate and then dried at 80° C. in a constant temperature blast oven to obtain a graphene conductive film. These graphene conductive films were respectively connected to a conductive path to test the conductivity, and test results were similar to those in FIGS. 2A-J.

The dispersity of the modified graphene nanomaterial was tested, and the results were similar to those in FIG. 3. The conductivity of the graphene conductive film was tested by four-point probe method, and the results were similar to those in FIGS. 4A-C.

This embodiment provides a modified graphene nanomaterial and a preparation thereof In the preparation method, the solvent of isopropanol and water (Vᵢₛₒₚᵣₒₚₐₙₒₗ/V_{water}=3:2)) with surface tension matching the surface energy of grapheme is used to reduce the effect of Van der Waals' force between graphite layers, and a peeling efficiency is further improved through the π-π conjugation of the SAS with conjugation effect and the graphite surface. In addition, the modified graphene nanomaterial is prepared by peeling the graphite through mechanical shearing of a circular ball mill. The modified graphene nanomaterial is able to be stably dispersed in solvents, ensuring dispersion stability of the graphene-based conductive ink.

This embodiment provides graphene-based conductive ink and a preparation thereof In the preparation method, the liquid phase exfoliation process is simple and feasible, and the graphene-based conductive ink is green and environmentally friendly and has a wide range of adaptation. The modified graphene nanomaterial provided herein can be stably dispersed in the graphene-based conductive ink, ensuring the long-term effectiveness of the graphene-based conductive ink. In addition, the graphene-based conductive ink has an excellent printing adaptability and can be stably dispersed in solvents, including water, ethanol, ethylene glycol, glycerol, isopropanol, n-butanol, DMF and NMP. At the same time, the graphene-based conductive ink has excellent conductivity and film-forming, rheological and mechanical properties as a printed conductive material. As a consequence, the graphene-based conductive ink provided herein is expected to be applied in printing flexible electronic devices.

The above are only preferred embodiments of this application, and are not intended to limit the scope of this application. Any changes and modifications made by those skilled in the art without departing from the spirit and principle of this application shall fall within the scope of this application defined by the appended claims.

What is claimed is:

1. A graphene-based conductive ink, comprising:
a modified graphene nanomaterial;
a first solvent; and
an ink binder;
wherein a weight ratio of the modified graphene nanomaterial to the first solvent to the ink binder is (2-4):(50-100):(1-2); and the first solvent is a mixture of water and a first alcohol;
the modified graphene nanomaterial is prepared by subjecting a mixture of sodium sulfanilate, a natural flake graphite and a second solvent to liquid phase exfoliation; and
the second solvent is a mixture of water and a second alcohol.

2. The graphene-based conductive ink of claim 1, wherein a particle size of the natural flake graphite is 4000-10000 mesh.

3. The graphene-based conductive ink of claim 1, wherein the particle size of the natural flake graphite is 8000 mesh.

4. The graphene-based conductive ink of claim 1, wherein a weight ratio of the natural flake graphite to the sodium sulfanilate is 1:(0.2-10).

5. The graphene-based conductive ink of claim 1, wherein the weight ratio of the natural flake graphite to the sodium sulfanilate is 1:(0.5-2).

6. The graphene-based conductive ink of claim 1, wherein a volume ratio of the water to the first alcohol in the first solvent is 1:(0.5-2).

7. The graphene-based conductive ink of claim 1, wherein the volume ratio of the water to the first alcohol in the first solvent is 2:3.

8. The graphene-based conductive ink of claim 1, wherein a volume ratio of the water to the second alcohol in the second solvent is 1:(0.5-2).

9. The graphene-based conductive ink of claim 1, wherein the volume ratio of the water to the second alcohol in the second solvent is 2:3.

10. The graphene-based conductive ink of claim 1, wherein the first alcohol and the second alcohol are independently a lower alcohol.

11. The graphene-based conductive ink of claim 10, wherein the lower alcohol is selected from the group consisting of: ethanol, ethylene glycol, glycerol, isopropanol, n-butanol and a combination thereof.

12. The graphene-based conductive ink of claim 10, wherein the lower alcohol is preferably isopropanol.

13. The graphene-based conductive ink of claim 1, wherein the ink binder is selected from the group consisting of: polyvinyl alcohol, polyethylene glycol, acrylic resin, epoxy resin, polyurethane resin, hydroxypropyl methylcellulose, nitrocellulose and a combination thereof.

14. A method of preparing the graphene-based conductive ink of claim 1, comprising:
(1) mixing the natural flake graphite, the second solvent and the sodium sulfanilate followed by ultrasonication to obtain a graphite dispersion;
(2) grinding the graphite dispersion obtained in step (1) to obtain a ground slurry;
(3) subjecting the ground slurry obtained in step (2) to centrifugal washing with a third solvent to obtain the modified graphene nanomaterial; and
(4) mixing the modified graphene nanomaterial obtained in step (3), the ink binder and the first solvent followed by ultrasonication and grinding to obtain the graphene-based conductive ink.

15. The method of claim 14, wherein in step (1), the ultrasonication is performed at an ultrasonic frequency of 5000 Hz for 60 s.

16. The method of claim 14, wherein in step (2), the grinding is performed in a medium of zirconia beads with a particle size of 2-3 mm for 12-24 h.

17. The method of claim 14, wherein in step (2), the grinding is performed at a rotation rate of 1000-2000 rpm.

18. The method of claim 14, wherein in step (3), the third solvent is a mixture of water and isopropanol.

19. The method of claim 18, wherein a volume ratio of the isopropanol to the water is 3:2.

20. The method of claim 14, wherein in step (4), the grinding is performed in a medium of zirconia beads with a particle size of 1-3 mm at a rotation rate of 100-500 rpm for is 1-2 h.
